(19) United States
(12) Patent Application Publication
(10) Pub. No.: US 2013/0283585 A1
(43) Pub. Date: Oct. 31, 2013

(54) System and Method for Repairing Microchannel Heat Exchanger

(71) Applicants: Vijesh R. Desireddy, Tyler, TX (US); Jay E. Field, Troup, TX (US)

(72) Inventors: Vijesh R. Desireddy, Tyler, TX (US); Jay E. Field, Troup, TX (US)

(73) Assignee: TRANE INTERNATIONAL INC., Piscataway, NJ (US)

(21) Appl. No.: 13/458,317

(22) Filed: Apr. 27, 2012

(51) Int. Cl. B23P 6/00; B23P 19/04

(52) U.S. Cl. 29/402.03; 29/402.01; 29/402.19; 29/402.18; 29/700

(57) ABSTRACT

A method of repairing a microchannel heat exchanger includes identifying a damaged region of a microchannel tube, providing sealant to at least one of the microchannel tube and a patch, and disposing the patch relative to the microchannel tube so that the sealant forms a fluid tight boundary between the microchannel tube and the patch, wherein the fluid tight boundary circumscribes the damaged region.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Microchannel tubes of heating, ventilation, and air conditioning (HVAC) heat exchangers may become damaged. Some microchannel tubes comprise materials that are not easily repaired using conventional techniques. Some microchannel tubes comprise features of such diminutive size that repair of such features using conventional techniques may not be predictably attainable.

### SUMMARY OF THE DISCLOSURE

In some embodiments, a method of repairing a microchannel heat exchanger is provided. The method may comprise identifying a damaged region of a microchannel tube, providing sealant to at least one of the microchannel tube and a patch, and disposing the patch relative to the microchannel tube so that the sealant forms a fluid tight boundary between the microchannel tube and the patch, wherein the fluid tight boundary circumscribes the damaged region.

In other embodiments, a method of repairing a refrigeration conduit is provided. The method may comprise identifying a damaged region of the refrigeration conduit and locating a patch configured to substantially cover and at least partially overlap the damaged region boundary an offset distance from the refrigeration conduit while the space between the patch and the damaged region boundary is filled with sealant.

In other embodiments, a repair kit for repairing a damaged microchannel tube is provided. The repair kit may comprise a patch configured to at least cover a damaged region of the microchannel tube and a sealant configured for filling a space between the patch and the microchannel tube.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a simplified orthogonal front view of a microchannel exchanger according to an embodiment of the disclosure;

FIG. 2 is a partial cutaway oblique view of two microchannel tubes and a fin of the microchannel heat exchanger of FIG. 1;

FIG. 3 is an orthogonal front view of an outdoor HVAC unit comprising the microchannel heat exchanger of FIG. 1;

FIG. 4 is an orthogonal front view of a damaged microchannel heat exchanger;

FIG. 5 is a repair kit for repairing the damaged microchannel heat exchanger of FIG. 4;

FIG. 6 is a flowchart of a method of repairing a damaged microchannel heat exchanger;

FIG. 7 is an orthogonal front view of the damaged microchannel heat exchanger with some fins removed;

FIG. 8 shows sealant being applied to the damaged microchannel heat exchanger of FIG. 7;

FIG. 9 shows sealant being applied to a patch of the repair kit of FIG. 5;

FIG. 10 shows the patch of FIG. 9 being applied to the damaged microchannel heat exchanger of FIG. 7; and

FIG. 11 is a schematic depiction of a damaged region of a microchannel tube and a plurality of possible patch boundaries.

### DETAILED DESCRIPTION

In some cases, a microchannel tube of an HVAC heat exchanger may be damaged so that one or more microchannels in the microchannel tube are undesirably opened to the environment. In some cases, the damage may allow refrigerant to escape from an otherwise closed loop refrigerant circuit of an HVAC system. In some cases, repair of the damaged microchannel tube may be attempted by utilizing a brazing process in which operating temperatures may be as high as 1100-1200° F. At such high temperatures, there is a possibility of further damaging the microchannel tube and a highly skilled technician is needed to attempt the repair. In other cases, repair of the damaged microchannel tube may be attempted by utilizing a vacuum-epoxy process. In some cases, epoxy may be applied to the damaged portion of the tube comprising an opening to the environment and a vacuum pressure may be applied to the damaged microchannel tube to draw some epoxy into the damaged microchannel tube via the opening. Reliability of repairs using the vacuum-epoxy process is unpredictable because it is difficult to meter and/or monitor the amount of epoxy drawn into the microchannel tube. As a result, the repair may fail after thermal cycling of the microchannel tube and/or pressure cycling of the microchannel tube. Further, if residual compressor oil within the microchannel tube is not fully removed, successful bonding between the microchannel tube and the epoxy may be prevented. Accordingly, this disclosure provides systems and methods for repairing a damaged microchannel HVAC heat exchanger tube with greater reliability and lower skill level.

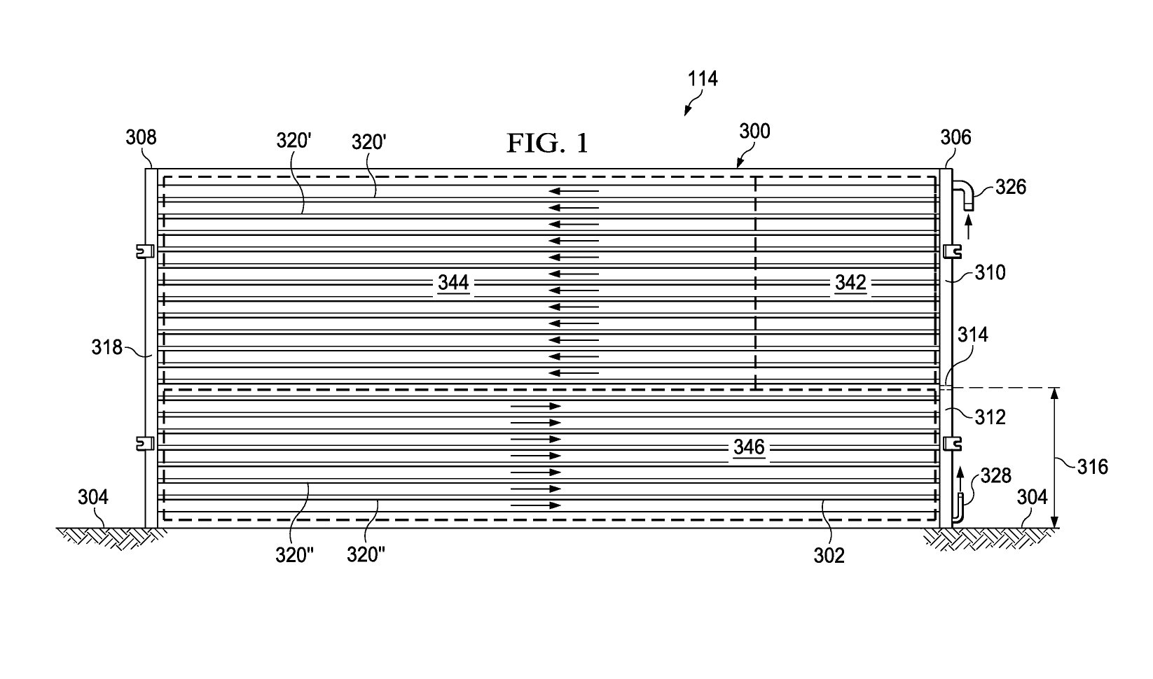

Referring now to FIG. 1, a simplified orthogonal front view of a microchannel heat exchanger 114 is shown. The microchannel heat exchanger 114 may be a component of an indoor or outdoor unit of an HVAC system and the microchannel heat exchanger 114 may be configured for use as a condenser and/or evaporator heat exchanger. While the microchannel heat exchanger 114 is shown in an unbent configuration, the microchannel heat exchanger 114 may alternatively be bent into a C-shape, U-shape, circular shaped, substantially square shape, and/or any other suitable configuration that may complement the remainder of the HVAC unit in which the microchannel heat exchanger 114 is disposed. The microchannel heat exchanger 114 generally comprises an upper end 300 and a lower end 302. The lower end 302 is generally configured to be vertically lower than the upper end 300, and in some embodiments, the lower end 302 may be located in close proximity to a support surface 304.

The microchannel heat exchanger 114 further comprises a divided header 306 and an undivided header 308. The divided header 306 is generally a tubular structure comprising an upper volume 310 and a lower volume 312. The upper volume 310 and the lower volume 312 are separated and prevented from directly communicating fluid between each other by a divider 314 disposed within the divided header 306. In alternative embodiments, the divided header 306 may be replaced by two physically separate headers. In this embodiment, the divider 314 is generally located a divider vertical offset distance 316 from the lower end 302. The undivided header 308 comprises a substantially similar tubular structure to that of the divided header 306, but the undivided header 308 comprises no internal structure analogous to the divider 314. Accordingly, the undivided header 308 comprises a substantially vertically continuous volume 318. The outdoor heat exchanger 114 further comprises a plurality of microchannel tubes 320 that extend horizontally between the divided header 306 and the undivided header 308. The microchannel tubes 320 join the divided header 306 and the undivided header 308 in fluid communication with each other.

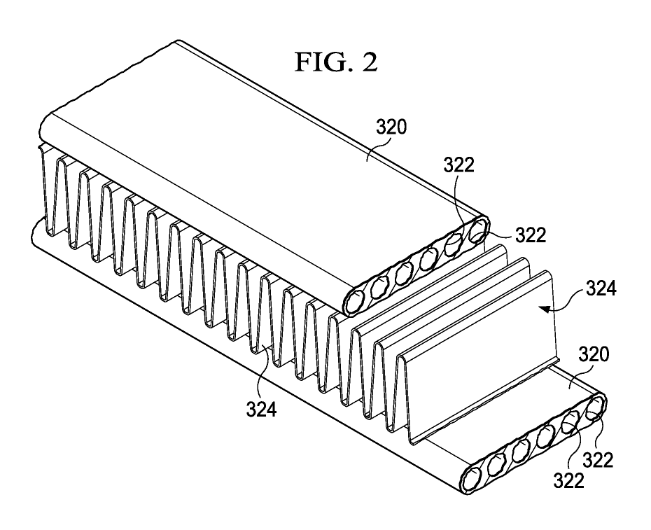

Referring now to FIG. 2, a partial cutaway oblique view of a plurality of microchannel tubes 320 is shown. In this embodiment, each microchannel tube 320 comprises a plurality of substantially parallel microchannels 322. Further, vertically adjacent microchannel tubes 320 may be joined to intermediately disposed thermally conductive fins 324. The fins 324 may comprise aluminum and/or any other suitable heat conductive material.

Referring back to FIG. 1, the thermally conductive fins 324 are not shown for clarity. The microchannel tubes 320 that supply refrigerant from the divided header 306 to the undivided header 308 may be referred to as supply microchannel tubes 320′ while the microchannel tubes 320 that supply refrigerant from the undivided header 308 to the divided header 306 may be referred to as return microchannel tubes 320″. The microchannel heat exchanger 114 further comprises a refrigerant inlet tube 326 in substantially direct fluid communication with an upper portion of the upper volume 310 of the divided header 306. The microchannel heat exchanger 114 also comprises a refrigerant outlet tube 328 in substantially direct fluid communication with a lower portion of the lower volume 312 of the divided header 306.

Under normal and/or ideal operating conditions, the microchannel heat exchanger 114 may be generally described as comprising three refrigerant characteristic regions: a hot gas region 342, a two-phase (liquid and vapor) region 344, and a subcooled liquid region 346. Because, under ideal and/or normal conditions, refrigerant is introduced into the outdoor heat exchanger 114 as hot gas, the hot gas will normally fill the upper volume 310 of the divided header 306 and travel in parallel paths through the supply microchannel tubes 320′. As the hot gas is cooled by ambient outdoor air being forced into contact with the outdoor heat exchanger 114, some of the hot gas may cool and condense to liquid form. Most generally, such initial condensation and conversion to liquid may occur in the two-phase region 344. When the condensed liquid reaches the undivided header 308, the liquid refrigerant may fall into the continuous volume 318 of the undivided header and become distributed into the various return microchannel tubes 320″ before exiting the microchannel heat exchanger 114.

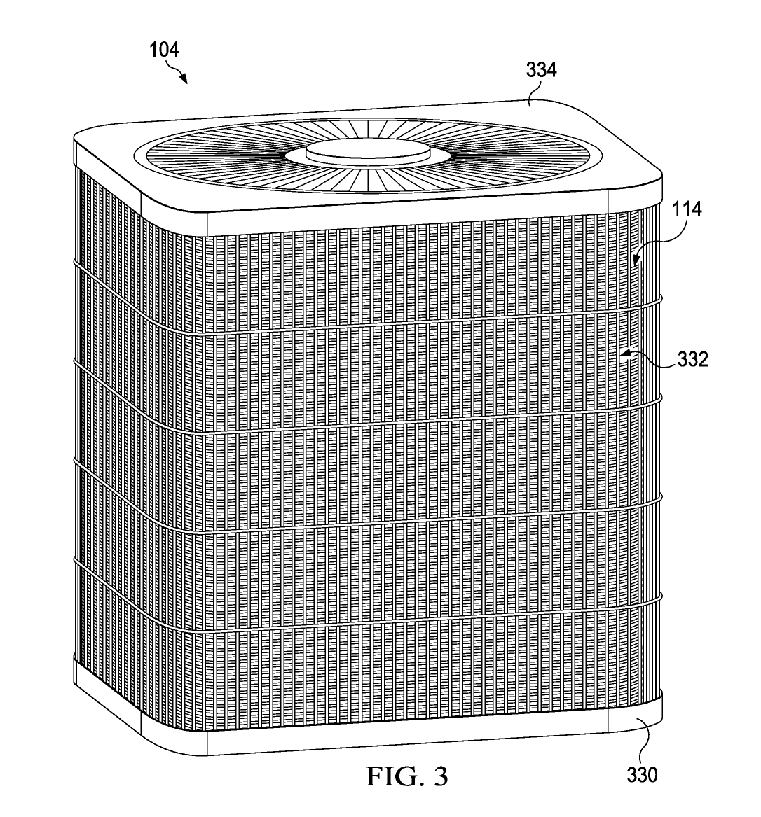

Referring now to FIG. 3, an oblique front view of an outdoor unit 104 comprising the microchannel heat exchanger 114 is shown. The outdoor unit 104 may further comprise a lower pan 330, a protective grille 332, and a top cover 334 for substantially enveloping and/or substantially encasing the microchannel heat exchanger 114.

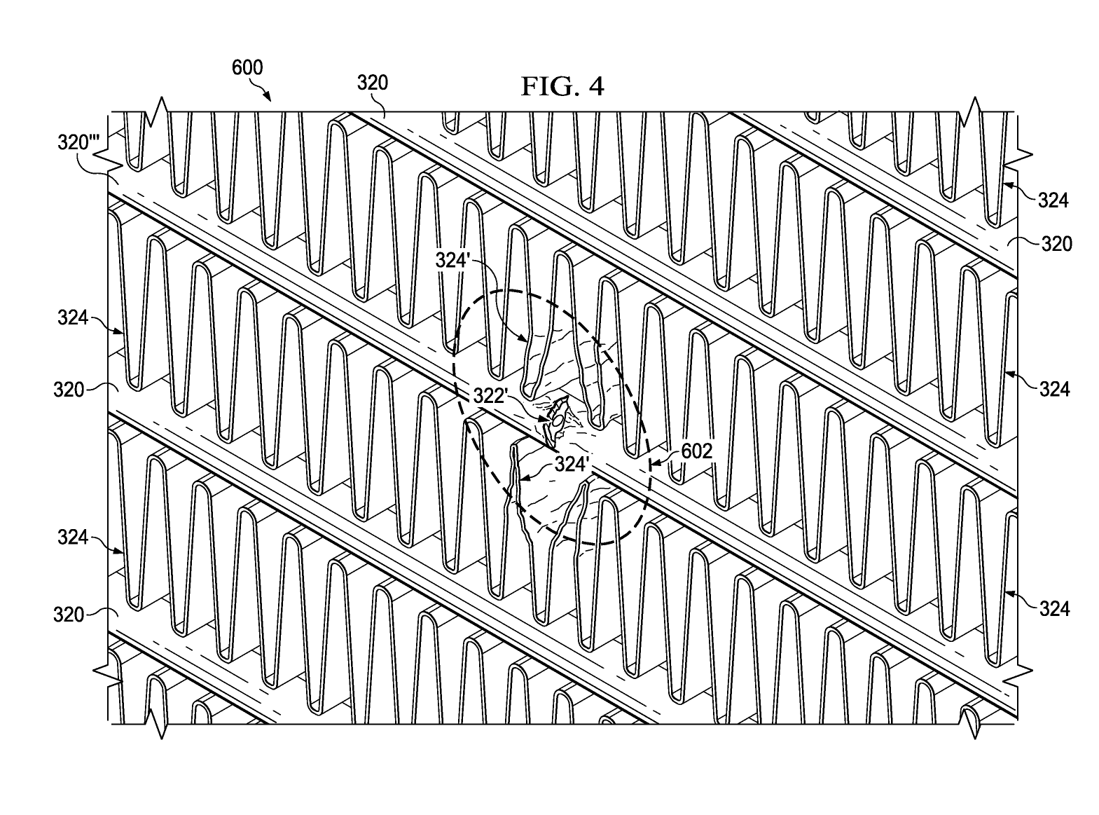

Referring now to FIG. 4, a damaged microchannel heat exchanger 600 is illustrated. The heat exchanger 600 is substantially similar to microchannel heat exchanger 114 but comprises a damaged region 602. In this embodiment, the damaged region 602 comprises both a damaged microchannel tube 320″′ and damaged fins 324′. The damaged region 602 further comprises a damaged microchannel 322′ that is open to the environment and may allow refrigerant to escape the damaged heat exchanger 600.

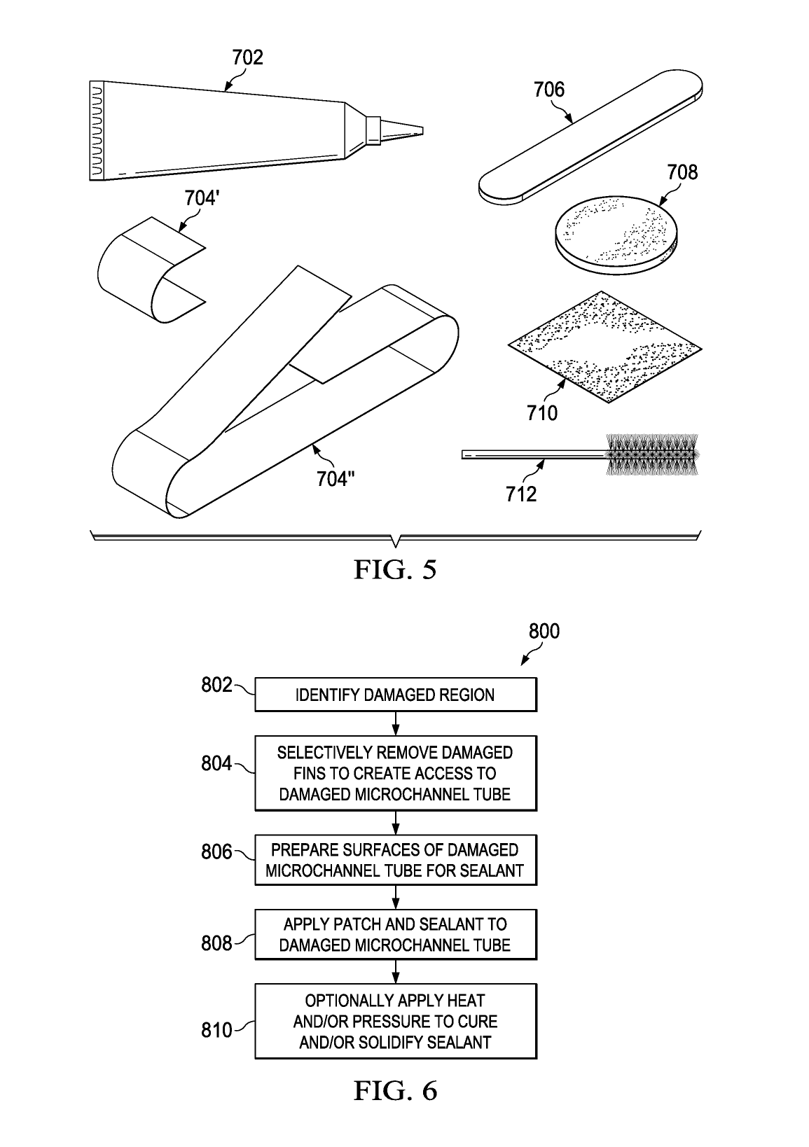

Referring now to FIG. 5, a microchannel tube repair kit 700 is shown. Repair kit 700 may comprise a container of sealant 702, such as, but not limited to, an epoxy sealant. In some embodiments, the sealant 702 may have a rated strength of at least about 3000-4000 psi. In some embodiments, the sealant 702 may comprise so-called rapid curing acrylic cyanoacrylate sealant/adhesive. In alternative embodiments, the sealant 702 may comprise silicones, urethanes, and/or phenolics. In some embodiments, sealant 702 may comprise separately packaged chemical components that may be combined at a time of use of the sealant 702. In other embodiments, the sealant 702 may be heat activated and/or activated by exposure to the atmosphere. Repair kit 700 may also comprise one or more patches 704. In some embodiments, a patch 704 may comprise a bent or unbent sheet of metal, such as, but not limited to, aluminum. Patches 704 may be provided in the repair kit 700 in preconfigured bent shapes suitable for conforming to one or more surfaces of a microchannel tube 320. For example, in some embodiments, a patch 704′ may be provided that is configured to extend and/or wrap from a top surface of a microchannel tube 320 to a bottom surface of the microchannel tube 320, but not completely encircle the microchannel tube 320. In other embodiments, a patch 704″ may be provided that is configured to extend and/or wrap substantially completely around a microchannel tube 320, thereby encircling the microchannel tube 320 with a sleeve of patch 704″ material.

The repair kit 700 may further comprise an applicator tool 706, a cleaning pad 708, sandpaper 710, and a tube brush 712. In some embodiments, the applicator tool 706 may comprise a wooden stick such as, but not limited to, a tongue depressor, popsicle stick, or the like. In some embodiments, the cleaning pad 708 may comprise a cloth and/or paper material pre-moistened with a cleaning agent, such as, but not limited to, rubbing alcohol. The sandpaper 710 may comprise abrasives selected for abrading metals, such as abrasives suitable for abrading aluminum and/or copper. The tube brush 712 may comprise metal wire bristles, such as, but not limited to, steel or brass bristles. In some embodiments, one or more of the elements of the repair kit 700 may be utilized to repair a damaged microchannel heat exchanger such as damaged microchannel heat exchanger 600.

Referring now to FIG. 6, a flowchart of method 800 of repairing a damaged microchannel heat exchanger 600 is shown. The method 800 may begin at block 802 by identifying and/or locating a damaged region of a microchannel heat exchanger, such as damaged region 602. In some cases, damage may be visually ascertained easily while in other cases refrigerant leak detection techniques such as use of electronic refrigerant sniffing leak detectors and/or fluorescent dye leak detectors may be utilized. After identifying a damaged region, the method 800 may progress to block 804.

At block 804, the method 800 may continue by selectively removing damaged fins to create adequate access to a damaged microchannel tube, such as damaged microchannel tube 320″′. In some cases, pliers, a knife, and/or a razor blade box cutter may be used to separate damaged and/or adjacent fins 324 from the vicinity of the location of the damage to the microchannel tube. In some embodiments, approximately one inch of fin space centered left-right on the damaged portion of the microchannel tube may be removed/cleared on each of the upper and lower sides of the microchannel tube. In some cases, removing fins that are adjacent but not damaged may provide improved access to a damaged microchannel tube.

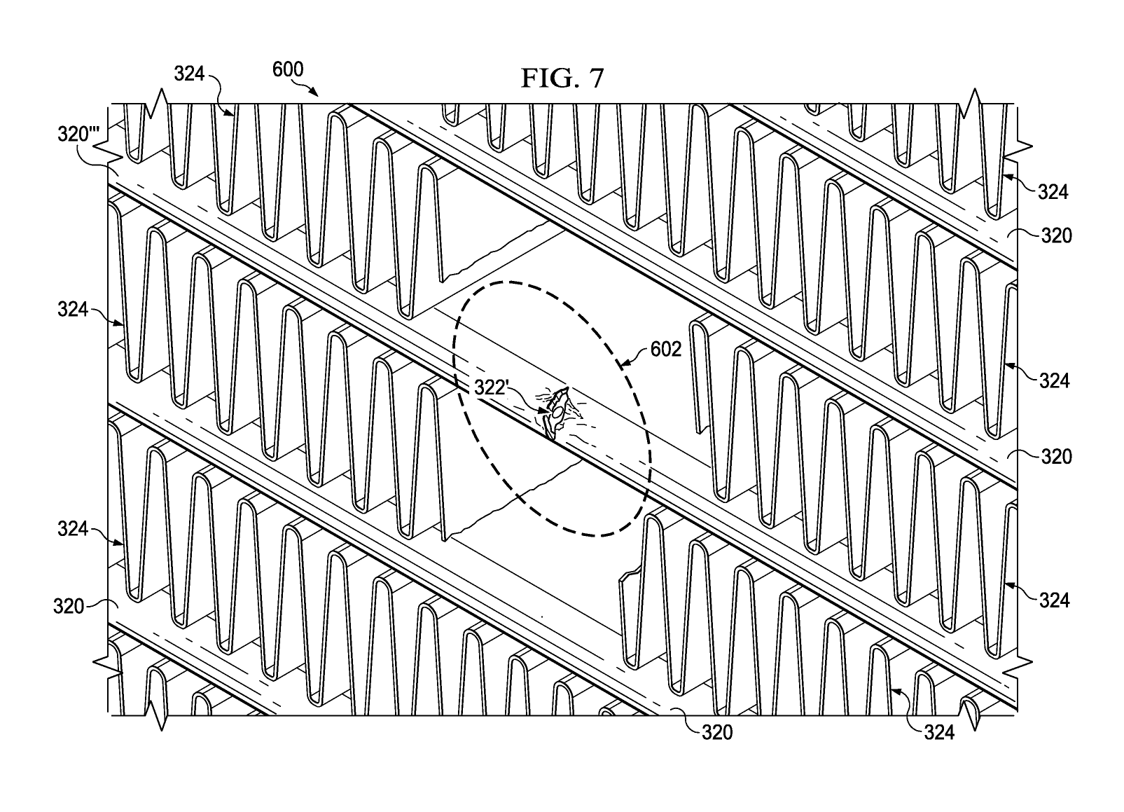

Referring now to FIG. 7, a damaged heat exchanger 600 is illustrated with damaged fins 324′ removed from the damaged region 602 and further removed from within about one inch centered left-right on each of the upper and lower sides of the damaged microchannel tube 320″′ in accordance with block 804 described above.

Referring back to FIG. 6, after the above-described removal of fins, the method 800 may continue to block 806. At block 806, the method may continue by preparing surfaces of the damaged microchannel tube 320″′ for receiving sealant 702, such as epoxy sealant 702. In some embodiments, aluminum oxide sandpaper 710 may be used to remove and/or reduce rough edges on the upper and/or lower portions of the damaged microchannel tube 320″′. In some embodiments, the sandpaper 710 may additionally be used to roughen one or more surfaces of a patch 704 to likewise prepare the patch 704 to receive sealant 702. In some embodiments, the surfaces of the damaged microchannel tube may further be prepared by using the tube brush 712 to vigorously brush away any powder flux. Still further, in some embodiments, the surfaces may further be prepared by using the cleaning pad 708 that may be pre-moistened with alcohol to remove any dirt, debris, and/or oils. After preparing the surfaces of the damaged microchannel tube, the microchannel tube may be allowed to dry so that no alcohol remains on the damaged microchannel tube. After preparing the surfaces, the method 800 may progress to block 808.

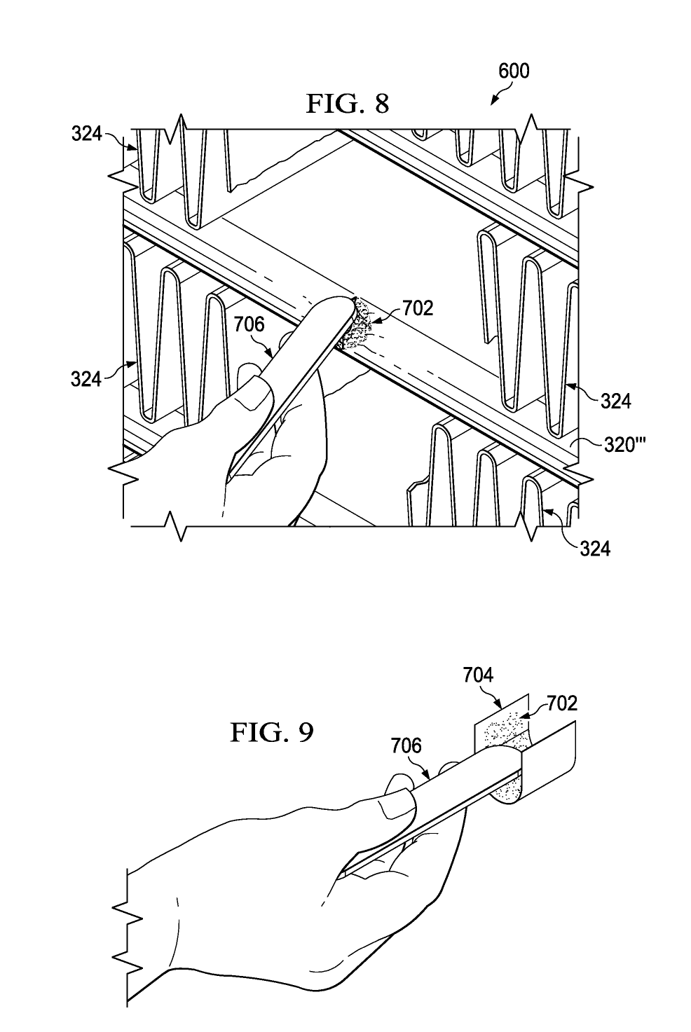

At block 808, the method may continue by applying a patch 704 and/or sealant 702 to the damaged microchannel tube. In some embodiments, sealant 702 may be applied to one or more of the surfaces of the damaged microchannel tube (see FIG. 8) and/or the patch 704 (see FIG. 9) prior to applying the patch 704 to the damaged microchannel tube. In some embodiments, sealant 702 may be so liberally applied over the damaged portion of the damaged microchannel tube that the applied sealant 702 may substantially fill an indentation, void, concavity, and/or hole not normally present on an undamaged microchannel tube. In some embodiments, sealant 702 may also be so liberally applied to the patch that sufficient sealant is carried by the patch 704 to the damaged microchannel tube to substantially fill an indentation, void, concavity, and/or hole not normally present on an undamaged microchannel tube upon pressing the patch 704 against the damaged microchannel tube. In some embodiments, a predetermined amount of sealant 702 may be metered and/or specially provided as a function of a previously surveyed damaged microchannel tube so that the amount of sealant 702 provided in a repair kit 700 may be optimized for the actual damage to be repaired.

With sufficient and suitable placement of sealant 702 on at least one of the damaged microchannel tube and a patch 704, the patch 704 may be applied to the damaged microchannel tube. In some embodiments, the patch 704 may be located so that a primary portion of the damage to the damaged microchannel tube is substantially centered left-right relative to the longitudinal length of the patch 704 (as opposed to circumferentially around a microchannel tube). After applying the patch 704 to the damaged microchannel tube, the method may progress to block 810.

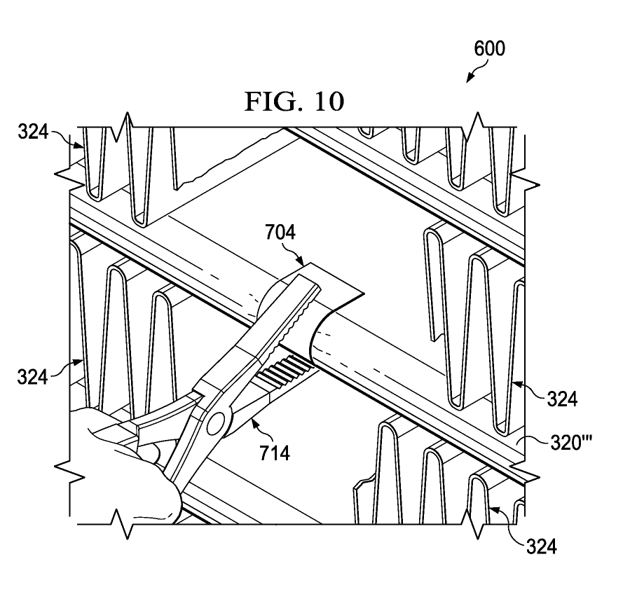

At block 810, the method may progress by selectively applying heat and/or pressure. In some embodiments, pressure may be applied to the patch 704 using pliers 714 (see FIG. 10), such as, but not limited to, needle nose pliers and/or locking pliers to press the patch 704 against the damaged microchannel tube. Additionally and/or instead of applying pressure, heat may be applied to the patch 704, sealant 702, and/or damaged microchannel tube. Heat may be applied using a so-called heat gun, hair dryer, electric lamp, and/or any other suitable source of heat. The above-described application of pressure and/or heat, in some embodiments, may be required to cure, set, harden, solidify, and/or otherwise make permanent the joining of the patch 704 to the damaged microchannel tube. In other embodiments, the above-described application of pressure and/or heat may hasten the curing, setting, hardening, solidifying, and/or otherwise making permanent the joining of the patch 704 to the damaged microchannel tube. After sufficient time has elapsed, sufficient pressure has been applied, and/or sufficient heat has been applied, the damaged microchannel tube is repaired. In some embodiments, heat may be applied for about 15 to about 20 minutes and about an additional 30 minutes may be allowed for the sealant to cure.

In some embodiments, a patch 704 may comprise a solid sheet of material, such as aluminum, that is folded or bent along a middle portion into one or more opposing surfaces. In some embodiments, a patch 704 may be about 0.02 inches to about 0.03 inches thick, and may be formed form a flat sheet of material that is a rectangle of about 1 inch by about 2 inches. In some embodiments, the patch 704 may be dimensioned to allow about 0.005 to about 0.01 inches of space for receiving sealant 702 between the patch 704 and a damaged microchannel tube. In some embodiments, multiple patches 704 may be used and/or joined to each other and/or to a same damaged portion of a microchannel tube. In some embodiments, the sealant 702 may be cured using a temperature greater than a normal operating temperature of the damaged microchannel tube.

In some embodiments, the patch 704 may be made of a same material as the damaged microchannel tube. For example, the patch 704 and the damaged microchannel tube may both be made of aluminum or both be made of copper. In some cases, constructing the patch 704 out of the same material as the damaged microchannel tube ensures that the thermal expansion coefficients are the same thereby helping to prevent formation of leaks subsequent to repair due to thermal expansion. In some embodiments, the patch 704 may comprise a V-shape. In some embodiments, a larger patch 704 and/or larger surface area of patch-microchannel tube may be supplied sealant 702 so that greater HVAC system operating pressures may be withstood by the above-described repair. In some embodiments, the sealant 702 may comprise an epoxy capable of withstanding at least 3000 pounds per square inch (psi) of pressure, which may be more than sufficient in HVAC systems that use either R-410A refrigerant and operate at approximately 700 psi or HVAC systems that use carbon dioxide based refrigerant at pressures of about 1800 psi.

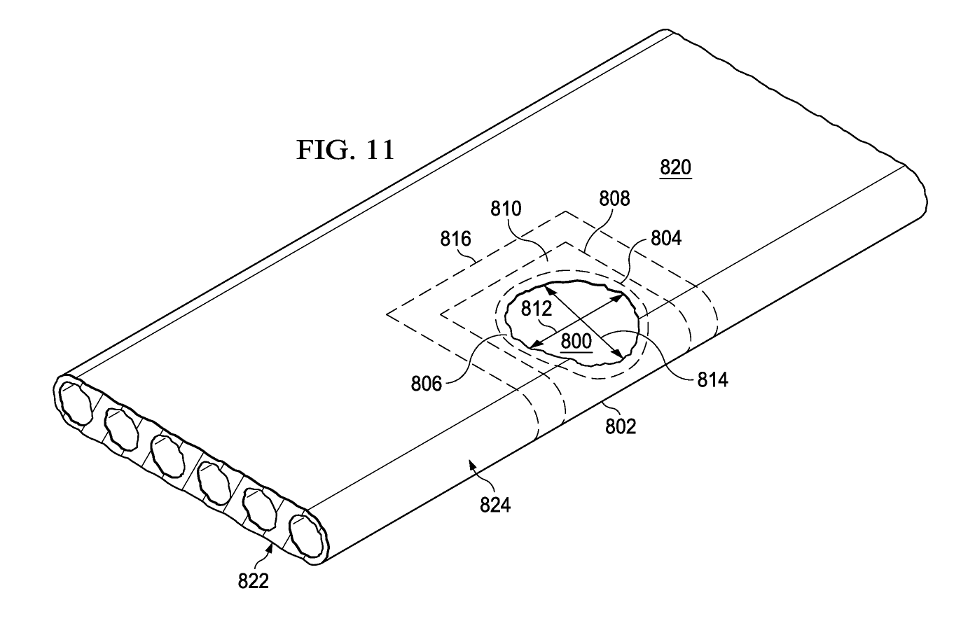

Referring now to FIG. 11, a schematic depiction of a damaged region 800 of a microchannel tube 802 is shown. In some embodiments, a patch 704 comprising an outer boundary 804 may be mechanically sufficient for repairing the damage if at least substantially all of the projected space 806 between the boundary 804 and the region 800 is properly filled with sealant 702. However, for ease of application, a larger patch 704 comprising an outer boundary 808 may be utilized to provide a greater space 810 of sealed contact between the larger patch 704 and the microchannel tube 802. In some cases, a size of a patch 704 may be selected based on a greatest longitudinal distance 812 of the damaged region 800 and a greatest transverse distance 814 of the damaged region 800. In some embodiments, a patch 704 may be selected to have a predetermined minimum amount of longitudinal and/or transverse overhang beyond the extents of the damaged region. Such a predetermined minimum amount of overhang may be established as a function of anticipated operating pressures of the microchannel tube 802. For example, if a patch 704 having an outer boundary 808 were selected for a microchannel tube 802 expected to operate at up to about 1000 psi, a patch 704 having an outer boundary 816 may be selected for a microchannel tube 802 expected to operate at up to about 2000 psi. The outer boundary 816 may provide a greater amount of complementary surface area to be sealed between the patch 704 and the microchannel tube 802. With proper location and sealing of a patch 704 to the microchannel tube 802 a fluid tight seal may circumscribe the damaged region 800 and prevent fluid flow into or out of the heat exchanger through the damaged portion of the microchannel tube. In some embodiments, the circumscribing may take place substantially only along a top surface 820 of the microchannel tube 802. In some embodiments, the circumscribing may take place substantially only along a bottom surface 822 of the microchannel tube 802. As shown in FIG. 13 the circumscribing may take place along at least one of the top and bottom surfaces 820, 822 as well as an intermediate surface joining the top and bottom surfaces 820, 822, such as a front surface 824. So long as the potentially refrigerant leaking portion of the damage is circumscribed and sealed to a patch, the damage may be repaired using one or more of the patches 704 and sealants 702 disclosed herein.

This disclosure further contemplates that a kit substantially similar to kit 700 and a method substantially similar to method 800 may be utilized to repair damage located substantially at a joint and/or interface between a microchannel tube and a header, damage located on a header, damage on a refrigerant tube that does not comprise microchannels, and/or any other refrigerant conduit. Of course, as described above, the patch may comprise a material having a coefficient of thermal expansion substantially similar to the damaged material and a kit may comprise a plurality of patches comprising different materials. In some cases, a repair person may select a patch from a kit based on the material that is damaged and may further trim or otherwise shape and/or customize the patch.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru−RI), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

1. A method of repairing a microchannel heat exchanger, comprising:
identifying a damaged region of a microchannel tube;
providing sealant to at least one of the microchannel tube and a patch; and
disposing the patch relative to the microchannel tube so that the sealant forms a fluid tight boundary between the microchannel tube and the patch, wherein the fluid tight boundary circumscribes the damaged region;
wherein the microchannel tube comprises a plurality of microchannels, and wherein the sealant is in contact with the patch and is in fluid communication with at least one of the microchannels of the microchannel tube.

2. The method of claim 1, further comprising:
removing a fin from the microchannel tube.

3. The method of claim 1, further comprising:
sanding at least a portion of at least one of the patch and the microchannel tube.

4. The method of claim 1, further comprising:
brushing at least a portion of the microchannel tube.

5. The method of claim 1, further comprising:
cleaning at least a portion of the microchannel tube with a cleaning pad pre-moistened with rubbing alcohol.

6. The method of claim 1, further comprising:
substantially filling a recessed portion of the damaged region with the sealant.

7. The method of claim 1, further comprising:
applying pressure to the microchannel tube via the patch and the sealant.

8. The method of claim 1, further comprising:
applying heat to the sealant.

9. The method of claim 1, wherein the patch comprises substantially the same material as the microchannel tube.

10. The method of claim 1, wherein the patch extends over at least one of a top surface and a bottom surface of the microchannel tube as well as an intermediate surface that joins the top surface to the bottom surface.

11. The method of claim 1, wherein the patch comprises aluminum.

12. The method of claim 1, wherein the sealant comprises at least one of an epoxy, a cyanoacrylate, a silicone, a urethane, and a phenolic.

13. A method of repairing a refrigerant conduit, comprising:
identifying a damaged region of the refrigerant conduit; and
locating a patch configured to substantially cover and at least partially overlap the damaged region boundary an offset distance from the refrigerant conduit while the space between the patch and the damaged region boundary is filled with sealant;
wherein the sealant is in contact with the patch and is in fluid communication with an interior of the refrigerant conduit.

14. The method of claim 13, further comprising:
applying at least one of pressure and heat to the patch.

15. The method of claim 13, further comprising:
preparing at least one surface of at least one of the refrigerant conduit and the patch prior to applying sealant to the prepared surface.

16. The method of claim 15, wherein the preparing comprises at least one of sanding, brushing, and cleaning with rubbing alcohol.

17. A repair kit for repairing a damaged microchannel tube, comprising:
a patch configured to at least cover a damaged region of the microchannel tube; and
a sealant configured for filling a space between the patch and the microchannel tube.

18. The repair kit of claim 17, wherein the patch comprises aluminum.

19. The repair kit of claim 18, further comprising at least one of an applicator configured for use in applying the sealant, sandpaper, a cleaner pad pre-moistened with rubbing alcohol, and brush.

20. The repair kit of claim 19, wherein the sealant comprises epoxy.
